(19) United States
(12) Patent Application Publication
(10) Pub. No.: US 2007/0019394 A1
(43) Pub. Date: Jan. 25, 2007

(54) Backlight unit and liquid crystal display comprising the same

(76) Inventors: Hye-eun Park, Suwon-si (KR); Dong-seob Jang, Seoul (KR); Seong-ho Youn, Hwaseong-si (KR); Chang-ju Kim, Suwon-si (KR); Seung-jae Lee, Suwon-si (KR)

Correspondence Address: STANZIONE & KIM, LLP, 919 18TH STREET, N.W., SUITE 440, WASHINGTON, DC, 20006, US

(21) Appl. No.: 11/411,034

(22) Filed: Apr. 26, 2006

(30) Foreign Application Priority Data
Jul. 22, 2005 (KR) 2005-66914

(51) Int. Cl. G01D 11/28

(52) U.S. Cl. 362/29; 362/631

(57) ABSTRACT

A backlight unit includes a point light source circuit board, a plurality of point light sources mounted onto the point light source circuit board, and an optical plate having a first surface that faces toward the point light source and is formed with an accommodating part to accommodate the point light source.

### CROSS-REFERENCE TO RELATED APPLICATIONS

This application claims priority under 35 U.S.C. §119(a) from Korean Patent Application No. 2005-0066914, filed on Jul. 22, 2005, in the Korean Intellectual Property Office, the disclosure of which is incorporated herein by reference.

### BACKGROUND OF THE INVENTION

1. Field of the Invention

The present general inventive concept relates to a backlight unit and a liquid crystal display (LCD) including the same, and more particularly, to a backlight unit and an LCD including the same, in which the backlight unit includes an optical plate to enhance a color mixture of point light sources.

2. Description of the Related Art

Recently, various flat panel displays such as a liquid crystal display (LCD), a plasma display panel (PDP), an organic light emitting diode (OLED), etc. have been developed as an alternative to a cathode ray tube (CRT).

Among them, the LCD includes an LCD panel that has a thin film transistor (TFT) substrate; a color filter substrate; and liquid crystals sandwiched between the two substrates. The LCD panel cannot emit light by itself, so a backlight unit is additionally provided behind the TFT substrate to illuminate the LCD panel. Transmission of light emitted from the backlight unit is varied according to an arrangement of the liquid crystals. Here, the LCD panel and the backlight unit are accommodated in a chassis.

The backlight unit is classified into an edge type and a direct type according to a position of a light source. The edge type backlight unit has a structure in which the light source is placed in an edge of a light guide plate, and is applied to a relatively small LCD such as a laptop computer, a desktop computer, etc. Such an edge type backlight unit is excellent in uniformity of light and its durability, and thus is advantageous to reduce a thickness of the LCD. However, the emitted light is attenuated while passing the light guide plate, so that optical efficiency of the edge type backlight unit is relatively low. Further, in the case of a large-sized LCD panel, its light guide plate cannot be manufactured by a single mold.

The direct type backlight unit has been developed as sizes of LCDs becomes larger. In the direct type backlight unit, one or more light sources are placed adjacent to the LCD panel so as to illuminate the entire surface of the LCD panel. Such a direct type backlight unit employs more light sources than the edge type backlight unit, so that high brightness is advantageously secured. However, the brightness is not uniform.

### SUMMARY OF THE INVENTION

The present general inventive concept provides a backlight unit and an LCD including the same, in which color uniformity and optical efficiency are enhanced.

Additional aspects and/or advantages of the present general inventive concept will be set forth in part in the description which follows and, in part, will be obvious from the description, or may be learned by practice of the present general inventive concept.

The foregoing and/or other aspects and utilities of the present general inventive concept can achieved by providing a backlight unit comprising a point light source circuit board, a plurality of point light sources mounted onto the point light source circuit board, and an optical plate having a first surface that faces toward the point light source and a plurality of accommodating parts each to accommodate a respective one of the plurality of point light sources.

Each of the accommodating parts can comprise a circular mouth.

A diameter of the mouth can be smaller than a depth of the respective accommodating part.

A ratio of the depth of the accommodating part to the diameter of the respective mouth can range from about 1 to 5.

A cross-section of each accommodating part in a horizontal direction can decrease from a mouth thereof toward an inside thereof.

The first surface can include a reflective coating film.

Each accommodating part can have a second surface opposite to the first surface and can include a recess having a cone shape.

The second surface can include a scattering pattern.

An angle between the second surface and a side of the recess can range from about 135 degrees to about 180 degrees.

The plurality of point light sources can comprise red, green and blue light emitting diodes.

The plurality of point light sources can comprise a white light emitting diode.

The optical plate can include polymethylmethacrylate.

The foregoing and/or other aspects and utilities of the present general inventive concept can also achieved by providing a liquid crystal display comprising a liquid crystal display panel, a point light source provided in a rear surface of the liquid crystal display panel, and an optical plate located between the liquid crystal display panel and the point light source, and having a first surface that faces toward the point light source and includes an accommodating part to accommodate the point light source.

The accommodating part can comprise a circular mouth.

A diameter of the mouth can be smaller than a depth of the accommodating part.

A ratio of the depth of the accommodating part to the diameter of the mouth can range from about 1 to 5.

The liquid crystal display can further comprise a light adjuster located between the liquid crystal display panel and the optical plate.

The light adjuster can comprise at least one of a diffusing plate, a prism film, and a polarization film.

The foregoing and/or other aspects and utilities of the present general inventive concept may also be achieved by providing a backlighting unit to transmit light to an image display panel, comprising at least one light source to emit light, and an optical plate to change the light emitted from the at least one light source into plane light and to uniformly transmit the plane light to the image display panel, the optical plate comprising an accommodating part to accommodate a respective one of the at least one light source.

The accommodating unit can be recessed from a first surface of the optical plate to accommodate the respective one of the at least one light source and to change the light emitted from the respective one of the at least one light source. The first surface of the optical plate can include a reflective coating film to reflect the light emitted from at least one light source to the image display panel. The reflective coating film can include a coating of silver or aluminum. The optical plate can include a second surface opposite to the first surface and having a scattering pattern to scatter the light emitted from the at least one light source toward the image display panel. The optical plate can include at least one indention corresponding to the at least one accommodating unit and recessed from a second surface of the optical plate. The at least one indentation can be recessed from the second surface at an angle of about 135 degrees to about 180 degrees. The optical plate can include at least one bump corresponding to the at least one accommodating unit and protruding from a second surface of the optical plate.

The foregoing and/or other aspects and utilities of the present general inventive concept may also be achieved by providing a image display device, comprising an image display panel, and a backlighting unit to transmit light to the image display panel, comprising at least one light source to emit the light and an optical plate to uniformly transmit the light emitted from the at least one light source to the image display panel, the optical plate comprising at least one accommodating part to accommodate a respective one of the at least one light source.

The accommodating part can be recessed from a first surface of the optical plate toward the image display panel to accommodate the at least one light source and to change a path of the light emitted from the at least one light source. The image display device can further comprise a light adjusting unit located between the backlight unit and the display panel to diffuse light emitted from the backlight unit.

The foregoing and/or other aspects and utilities of the present general inventive concept may also be achieved by providing a method of transmitting light emitted from a backlighting unit to an image display panel, the backlighting unit including at least one light source and an optical plate optical plate having at least one accommodating part on a first surface thereof to accommodate a respective one of the at least one light source, the method comprising emitting light from the at least one light source through the respective at least one accommodating part, transmitting a first portion of the emitted light to the image display panel, refracting a second portion of the emitted light on a second surface of the optical plate and transmitting the refracted second portion of the emitted light to the image display panel at an angle less than a predetermined angle, and reflecting a third portion of the emitted light between the first and second surfaces of the optical plate and transmitting the reflected third portion of the emitted light to the image display panel at an angle greater than a predetermined angle.

The second surface of the optical plate may include a recess at a location corresponding to the at least one accommodating part, the method may further comprising refracting at least one of the first and second portions of the emitted light through the recess before transmitting the at least one of the first and second portions of the emitted light to the image display panel. The second surface of the optical plate can include a bump at a location corresponding to the at least one accommodating part, the method further comprising reflecting the third portion of the emitted light on the bump before transmitting the third portion of the emitted light to the image display panel.

### BRIEF DESCRIPTION OF THE DRAWINGS

The above and/or other aspects and advantages of the present general inventive concept will become apparent and more readily appreciated from the following description of the embodiments, taken in conjunction with the accompany drawings of which:

FIG. 1 is an exploded perspective view illustrating an LCD according to an embodiment of the present general inventive concept;

FIG. 2 is a sectional view illustrating the LCD in FIG. 1;

FIG. 3 is a graph illustrating a non-uniformity of color in the LCD in FIG. 1; and

FIG. 4 is a sectional view illustrating an optical plate according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

Hereinafter, a light emitting diode (LED) will be described as an example of a point light source. However, the present general inventive concept is not limited to the point light source being an LED.

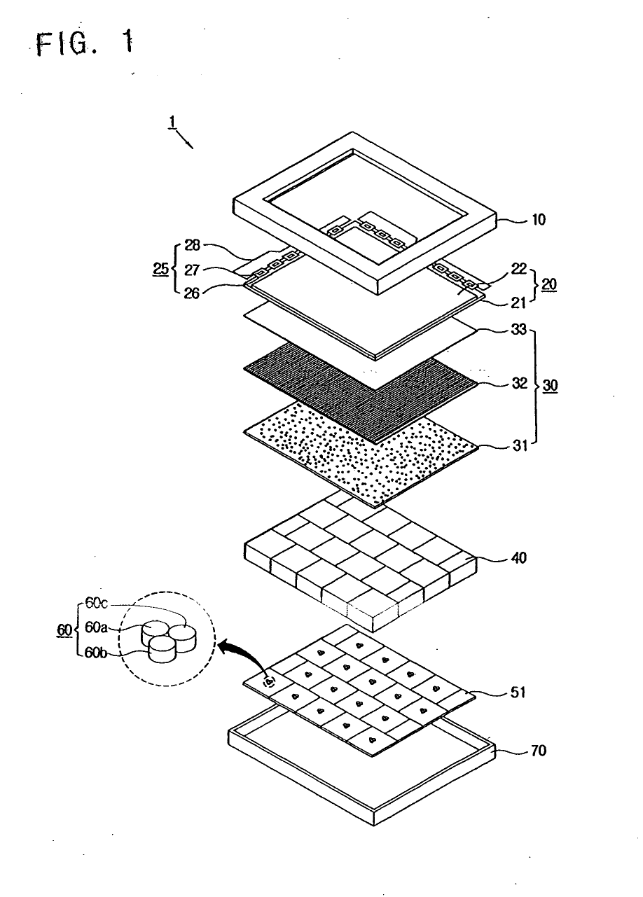

An LCD according to an embodiment of the present general inventive concept will be described with reference to FIGS. 1 through 3.

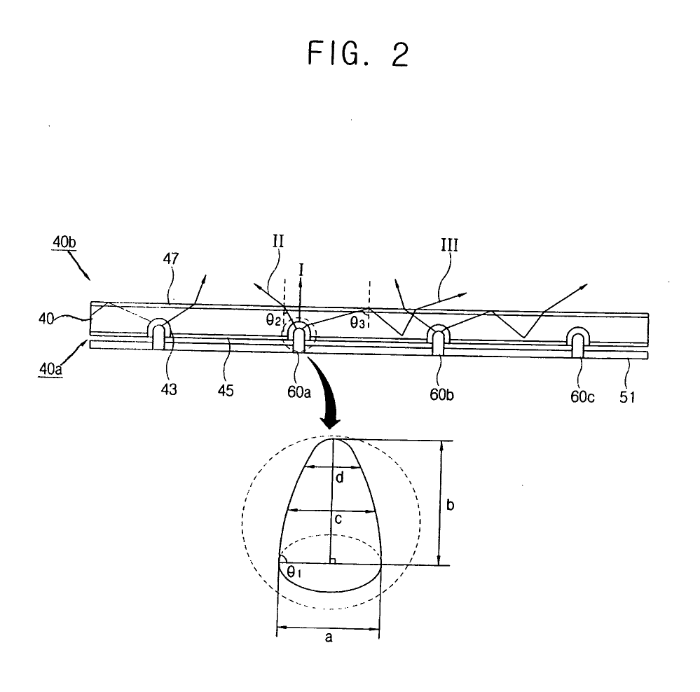

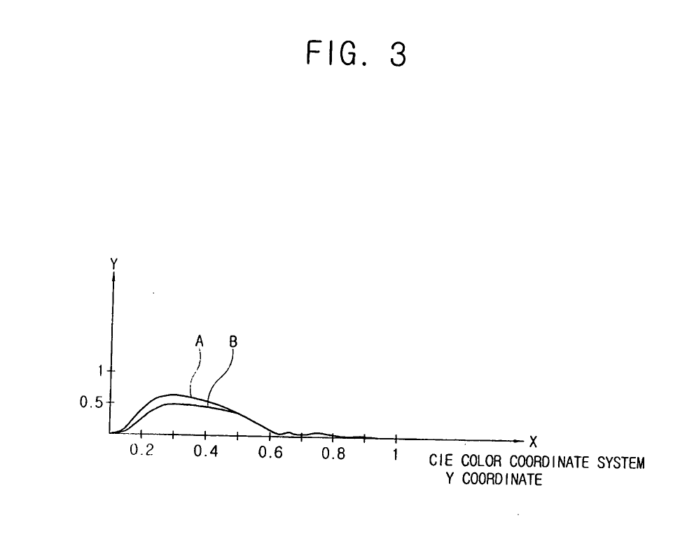

FIG. 1 is an exploded perspective view illustrating an LCD according to an embodiment of the present general inventive concept, FIG. 2 is a sectional view illustrating the LCD in FIG. 1, and FIG. 3 is a graph illustrating a non-uniformity of color in the LCD of FIG. 1.

The LCD 1 includes an LCD panel 20, a light adjuster 30, an optical plate 40, an LED circuit board 51, and an LED unit 60. Here, the light adjuster 30, the optical plate 40, and the LCD circuit board 51 are sequentially placed behind the LCD panel 20. Further, the LED unit 60 is mounted onto the LED circuit board 51 and accommodated in an accommodating part 43 of the optical plate 40 (see FIG. 2).

Also, the LCD panel 20, the light adjuster 30, and the LED circuit board 51 are accommodated between an upper chassis 10 and a lower chassis 70.

The LCD panel 20 can include a TFT substrate 21 formed with a thin film transistor; a color filter substrate 22 opposite to the TFT substrate 21; a sealant (not shown) coupling the two substrates 21 and 22 and forming a cell gap; and a liquid crystal layer (not shown) sandwiched between two substrates 21 and 22 and the sealant. The LCD panel 20 may have a rectangular shape having a long side and a short side, as illustrated in FIG. 1. However, the present general concept is not limited to the LCD panel 20 having the rectangular shape.

The LCD panel 20 forms an image by controlling an arrangement of the liquid crystal layer. However, the LCD panel 20 cannot emit light by itself, and thus receives light from a light source, such as the LED unit 60 placed in the back thereof. The TFT substrate 21 can be provided with a driver 25 at one side thereof to apply a driving signal. The driver 25 can include a flexible printed circuit (FPC) 26, a driving chip 27 mounted to the FPC 26, and a printed circuit board 28 connected to the FPC 26. By way of example, a chip on film (COF) type driver 25 is illustrated in FIG. 1, but the present general inventive concept is not limited to the driver 25 being a COF type driver. Alternatively, a tape carrier package (TCP) type driver, a chip on glass (COG) type driver, etc. can be used. Further, the driver 25 may be formed on the TFT substrate 21, forming a wiring line.

The light adjuster 30 placed behind the LCD panel can include a diffusing plate 31, a prism film 32, and a protection film 33.

The diffusing plate 31 may include a base plate, and a coating film having beads formed on the base plate. Here, the diffusing plate 31 diffuses the light emitted from the LED unit 60, thereby making the brightness uniform.

The prism film 32 is provided with triangular prisms regularly arranged on a top surface thereof. The prism film 32 collects the light diffused by the diffusing plate 31 in a direction perpendicular to the surface of the LCD panel 20. Two prism films 32 can be used, and a micro-prism provided in each prism film 32 forms a predetermined angle. The light passing through the prism film 32 moves in a direction perpendicular to the surface of the LCD panel 20, thereby making the brightness uniform. A reflective polarization film may be provided in addition to the prism film 32. Alternatively, the reflective polarization film may be used without the prism film 32.

The optical plate 40 may include a first surface 40a facing the LED unit 60, and a second surface 40b facing the LCD panel 20. The first surface 40a is formed with the accommodating part 43 to accommodate the LEDs 60a, 60b and 60c. A size of the optical plate 40 can be equal to that of the LED circuit board 51. Alternatively, the size of the optical plate 40 can be unequal but similar to that of the LED circuit board 51. A plurality of optical plates 40 can be arranged throughout an entire rear surface of the LCD panel 20. Each optical plate 40 is formed with the accommodating part 43 to accommodate the LED unit 60 protruding from the LED circuit board 51.

The optical plate 40 can be used in an edge type backlight unit, and can include a light guide plate to guide the light emitted from the light source toward the LCD panel 20. The optical plate 40 changes the light emitted from the LED unit 60 into plane light, and uniformly transmits the plane light to the LCD panel 20 through the second surface 40b. The optical plate 40 can be made of an acrylic resin, such as polymethylmethacrylate (PMMA), which has high strength so that it is not easily deformed or broken, and has good transmission.

The accommodating part 43 is recessed from the first surface 40a of the optical plate 40 toward the LCD panel 20 so as to have a domy or hemispheric shape surrounding the LED unit 60. Here, the shape of the accommodating part 43 acts as a lens to change a path of the light emitted from the LED unit 60. In other words, the optical plate 40 itself acts as an aspheric lens.

The accommodating part 43 may have a circular mouth and a depth “b” enough to accommodate the LED unit 60 (see FIG. 2). Further, the accommodating part 43 may have an approximately semi-elliptical cross-section in a vertical direction. A center region of the accommodating part 43 can be shaped like a hemisphere so as to transmit more light. As the depth “b” increases, the cross-section of the accommodating part 43 may decrease with respect to a perpendicular direction to the optical plate 40. In other words, the deeper the inside of the accommodating part 43, the smaller the cross-section of the accommodating part 43. As illustrated in FIG. 2, the cross-section (i.e., the width) of the accommodating part 43 decreases from “c” to “d” as the depth “b” from a horizontal surface increases.

A mouth of the accommodating part 43 has a diameter “a” smaller than the depth “b” thereof. A ratio of the depth “b” to the diameter “a” can range from about 1 to 5. In other words, a lateral region of the accommodating part 43 at an angle of θ₁ is steeper than a center region thereof, so that the light emitted from the LED unit 60 is sufficiently refracted at the lateral region. Therefore, more light emitted from the LED unit 60 passes through the lateral region rather than the center region. For example, the lateral region of the accommodating part 43 is formed at an angle of at least 45 degrees (i.e., 45 degrees or more) to the horizontal surface thereof. Here, the vertical direction cross-section of the accommodating part 43 is not limited to the semi-elliptical shape. Alternatively, the accommodating part 43 may have a vertical direction cross-section which is shaped to join an arc shape in the center region and a rectangular shape in the lateral region, in which the angle θ₁ of the lateral region is approximately 90 degrees.

The optical plate 40 can include the first surface 40a formed with a reflective coating film 45, and the second surface 40b formed with a scattering pattern 47.

The reflective coating film 45 can effectively reflect the light toward the LCD panel 20 when the light emitted from the LED unit 60 is not transmitted to the LCD panel 20 and returns to the first surface 40a of the optical plate 40. Therefore, the reflective coating film 45 acts as a reflective sheet that is provided on the LED circuit board 51 and reflects the light emitted from the LED unit 60. Here, the reflective coating film 45 can include polyethyleneterephthalate (PET) or polycarbonate (PC), and can be additionally coated with silver or aluminum. The reflective coating film 45 can be relatively thick so as to prevent wrinkles due to heat generated by the LED unit 60.

The second surface 40b can be formed with the scattering pattern 47. The lights emitted from the respective LED units 60 to the optical plate 40 are mixed or totally reflected in the optical plate 40, and then finally transmitted to the LCD panel 20 through the second surface 40b. In this case, the second surface 40b can be formed with a predetermined rough pattern of, for example, about 500 μm to more effectively scatter the totally reflected light toward the LCD panel 20. Here, the roughness of the pattern formed on the second surface 40b may be adjusted variously in consideration of the characteristic of the LED unit 60 and the refraction and the reflectivity of the optical plate 40.

The scattering pattern 47 and the reflective coating film 45 may be omitted. Therefore, the scattering pattern 47 and the reflective coating film 45 may be provided selectively in consideration of an optical efficiency of the light source, such as the LED unit 60, thereby enhancing the reflection and the scattering of the light.

The LED unit 60 can be mounted to the LED circuit substrate 51, and can be arranged throughout the entire rear surface of the LCD panel 20. The LED unit 60 includes a chip to emit light; a lead to connect the chip with the LED circuit board 51; a plastic mold to accommodate the lead and surrounding the chip; and silicon and a bulb placed above the chip, which are not shown.

The LED unit 60 can be classified as a side emitting type or a top emitting type according to a shape of the bulb. A side emitting type LED mostly emits light in a side direction, and a top emitting type LED mostly emits light in a top direction. In the side emitting type LED, color uniformity is high, but brightness is low. On the other hand, in the top emitting type LED, the brightness is high, but the color uniformity is low. In various embodiments of the present general inventive concept, the LED unit 60 is a top emitting type LED unit to increase brightness.

As illustrated in FIGS. 1 and 2, three LEDs 60a, 60b, and 60c are grouped into the LED unit 60 and mounted to the LED circuit board 51. Further, each LED unit 60 includes a red LED, a green LED and a blue LED, which are arranged to form a regular triangle.

Alternatively, the LED unit 60 may include only one white LED. In this case, the number of LEDs is decreased, and thus a production cost is reduced. Further, white light is emitted, so that a problem of color blemish, or non-uniformity of color, is solved. Also, the red LED, the green LED, the blue LED and the white LED may be grouped into one LED unit 60. In this case, the brightness and color mixture are enhanced.

The LED circuit board 51 may have a rectangular shape. The direction that the LED circuit boards 51 are arranged in one line can alternate the direction of those arranged in the next line. In other words, the LED circuit boards 51 can be arranged in a delta shape. One LED circuit board 51 can include the red, green and blue LEDs 60a, 60b and 60c. Since the LEDs 60a, 60b, and 60c generate much heat, the LED circuit board 51 can include aluminum, which is excellent in thermal conductivity. To radiate heat more effectively, the LCD 1 can include a heat pipe, a heat sink, a cooling pan, etc., which are not shown. The shape of the LED circuit board 51 and the arrangement of the LED unit 60 are not limited thereto, and may vary according to the LCD 1.

Below, light travel according to an embodiment of the present general inventive concept will be described in more detail with reference to FIGS. 1 and 2. FIGS. 1 and 2 illustrate that the LED unit 60 accommodated in the optical plate 40 includes the red LED 60a, the green LED 60b and the blue LED 60c, which are arranged in a line. However, as discussed above, the present general inventive concept is not limited to the LED unit 60 including the red LED 60a, the green LED 60b and the blue LED 60c. Furthermore, the present general inventive concept is not limited to the LEDs 60a, 60b, and 60c being arranged in a line.

The light emitted from the LED unit 60 is transmitted to the LCD panel 20 via various paths, and can be divided into three lights according to the paths. For example, a first light I can be emitted from the LED unit 60 and directly passes through the scattering pattern 47 without being refracted in the accommodating part 43, thereby traveling toward the LCD panel 20.

A second light II can be refracted on the second surface 40b of the optical plate 40 and passes through the light adjuster 30, thereby traveling toward the LCD panel 20. Thus, an incident angle of the second light II refracted on the second surface 40b is smaller than a critical angle for total reflection.

Here, “total reflection” means that when the light travels from an optically dense medium to an optically transparent medium and its incident angle is larger than a predetermined angle, all light is reflected without refraction on a separate surface between two mediums. In this case, the predetermined angle is called a critical angle. In the case where the critical angle is θ₀, the incident angle θ₂ of the second light II is smaller than the critical angle θ₀, so that the second light II is refracted on the second surface 40b.

A third light III can be emitted through a side of the accommodating part 43 and is totally reflected from the second surface 40b. Here, the incident angle θ₃ of the second light III is larger than the critical angle θ₀, so that it is totally reflected from the second surface 40b and then re-reflected from the first surface 40a. The third light III repeatedly totally reflects from the second surface 40b and re-reflects from the first surface 40a, and then finally travels toward the LCD panel 20 through the scattering pattern 47 like the second light II. Thus, as illustrated in FIG. 2, the light having a first color and emitted from one LED (e.g., the LED 60b) is mixed with lights having other colors and emitted from the adjacent LEDs (e.g., the LEDs 60a and 60c) through the total reflection and the re-reflection. Further, as a travel distance of the light becomes longer, the color mixture is increased. The more the light traveling in the optical plate 40 by passing through the side of the accommodating part 43 (i.e., being refracted in the accommodating part 43) the higher the probability of mixing different color lights. As the color mixture is increased, the color uniformity becomes higher among the different LEDs of the LED unit 60, thereby enhancing the brightness of the LCD panel 20.

FIG. 3 is a graph illustrating a non-uniformity of color with respect to a Y-axis in commission internationale de l'Eclairage (CIE) color coordinate system. In the graph, an X-axis indicates a value in the CIE color coordinate system, and the Y-axis relatively indicates the non-uniformity of the color. For example, in the CIE color coordinate system, yellow appears strongly where the X coordinate ranges from approximately 0.2 to approximately 0.6. In this range, the color mixture is not suitably achieved, thereby deteriorating the color uniformity.

As illustrated in FIG. 3, an “A” line indicates the non-uniformity of the color when a conventional backlight unit is used. In the conventional backlight unit, the non-uniformity of the color has a value ranging from about 0.5 to about 0.6 when the X coordinate is about 0.3. On the other hand, a “B” line indicates the non-uniformity of the color when a backlight unit according to an embodiment of the present general inventive concept is used. Using the backlight unit according to an embodiment of the present general inventive concept, the non-uniformity of the color has a value of 0.5 or below when the X coordinate is about 0.3. Thus, the non-uniformity of the color is decreased, i.e., the color uniformity of the LCD panel 20 is enhanced, thereby increasing the brightness of the LCD 1.

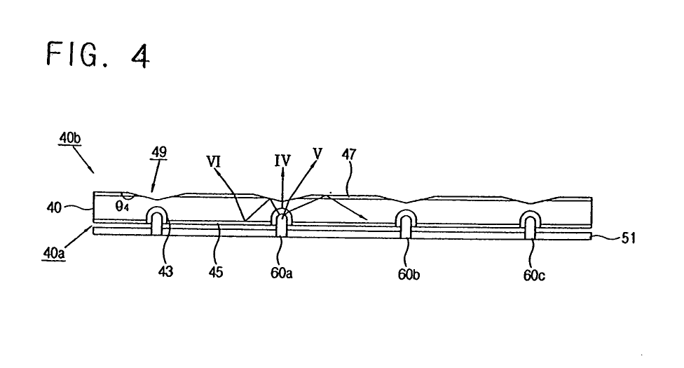

FIG. 4 is a sectional view illustrating a backlight unit, and more particularly, an optical plate according to an embodiment of the present general inventive concept. As illustrated in FIGS. 1 and 4, the second surface 40b of the optical plate 40 is formed with a recess 49 at a place corresponding to the accommodating part 43.

The recess 49 can be shaped like a cone and inwardly recessed from the second surface 40b. Therefore, as illustrated in FIG. 4, the cross-section of the recess 49 is approximately shaped like an inverted triangle. Here, the recess 49 is not coated with the scattering pattern 47, and has a curved surface to be employed as a lens to refract and reflect the light. The recess 49 is placed at a location corresponding to the location of the accommodating part 43, thereby not only decreasing the light that travels toward the top of the LED unit 60 (such as the first light I in FIG. 2 and a fourth light IV in FIG. 4), but also increasing the light that travels toward the side of the LED unit 60. Here, the first light I and the fourth light IV, which directly travel toward the top of the LED unit 60, cause the non-uniformity of the color on the LCD panel 20. Therefore, the light can be refracted in the recess 49 and then does not travel toward the top of the LED unit 60, but toward the side of the LED 60. As illustrated in FIG. 4, a fifth light V can be refracted in the recess 49 and can travel toward the LCD panel 20, and a sixth light VI can be totally reflected from the recess 49 and can be internally re-reflected in the optical plate 40.

Here, the recess 49 has a depth that is variable according to the thickness of the optical plate 40, or according to the size and the brightness of the corresponding LED. The recess 49 can have a depth so that an angle θ₄ between the second surface 40b and the side of the recess 49 ranges from approximately 135 degrees to approximately 180 degrees. When the angle θ₄ is too small, the refraction of the light is not suitable. On the other hand, when the angle θ₄ is too large, the recess 49 cannot suitably reflect and/or refract the light.

The recess 49, along with the accommodating part 43, increases the amount of light that travels in the optical plate 40, thereby enhancing the color mixture and elongating the optical path to improve an optical efficiency of the LCD 1. Therefore, when the accommodating part 43 alone is enough to get a suitable color mixture or to prevent light leakage from the LED unit 60, the recess 49 may be omitted.

Alternatively, the curved surface of the recess 49 may be shaped like a hemisphere. In other words, the recess 49 can have a concave surface instead of the inverted triangle. In this case, the surface area of the recess 49 increases, so that more light can be totally reflected in the optical plate 40.

As described above, the present general inventive concept provides a backlight unit and an LCD including the same, in which color uniformity and optical efficiency are enhanced.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A backlight unit comprising:
a point light source circuit board;
a plurality of point light sources mounted onto the point light source circuit board; and
an optical plate having a first surface that faces toward the point light source and comprises a plurality of accommodating parts to accommodate the plurality of point light sources.

2. The backlight unit according to claim 1, wherein each of the accommodating parts comprises a circular mouth.

3. The backlight unit according to claim 2, wherein a diameter of the mouth is smaller than a depth of the accommodating part.

4. The backlight unit according to claim 3, wherein a ratio of the depth of the accommodating part to the diameter of the mouth ranges from about 1 to 5.

5. The backlight unit according to claim 1, wherein a cross-section of each accommodating part in a horizontal direction decreases from a mouth thereof toward an inside thereof.

6. The backlight unit according to claim 1, wherein the first surface comprises a reflective coating film.

7. The backlight unit according to claim 1, wherein each accommodating part has a second surface opposite to the first surface and comprises a recess having a cone shape.

8. The backlight unit according to claim 7, wherein the second surface comprises a scattering pattern.

9. The backlight unit according to claim 7, wherein an angle between the second surface and a side of the recess ranges from about 135 degrees to about 180 degrees.

10. The backlight unit according to claim 1, wherein the plurality of point light sources comprises red, green and blue light emitting diodes.

11. The backlight unit according to claim 1, wherein the plurality of point light sources comprises a white light emitting diode.

12. The backlight unit according to claim 1, wherein the optical plate includes polymethylmethacrylate.

13. An liquid crystal display, comprising:
a liquid crystal display panel;
a point light source provided in a rear surface of the liquid crystal display panel; and
an optical plate located between the liquid crystal display panel and the point light source, and having a first surface that faces toward the point light source and comprises an accommodating part to accommodate the point light source.

14. The liquid crystal display according to claim 13, wherein the accommodating part comprises a circular mouth.

15. The liquid crystal display according to claim 14, wherein a diameter of the mouth is smaller than a depth of the accommodating part.

16. The liquid crystal display according to claim 14, wherein a ratio of the depth of the accommodating part to the diameter of the mouth ranges from about 1 to 5.

17. The liquid crystal display according to claim 13, further comprising a light adjuster located between the liquid crystal display LCD panel and the optical plate.

18. The liquid crystal display according to claim 17, wherein the light adjuster comprises at least one of a diffusing plate, a prism film, and a polarization film.

19. A backlighting unit to transmit light to an image display panel, comprising:
at least one light source to emit light; and
an optical plate to change the light emitted from the at least one light source into plane light and to uniformly transmit the plane light to the image display panel, the optical plate comprising an accommodating part to accommodate a respective one of the at least one light source.

20. The backlighting unit according to claim 19 wherein:
the accommodating unit is recessed from a first surface of the optical plate to accommodate the respective one of the at least one light source and to change the light emitted from the respective one of the at least one light source.

21. The backlighting unit according to claim 6, wherein:
the reflective coating film includes a coating of silver or aluminum.

22. The image display device according to claim 1, wherein:
the plurality of accommodating parts are recessed from a first surface of the optical plate toward the image display panel to accommodate the plurality of light sources and to change a path of the light emitted from the plurality of light sources.

23. A method of transmitting light emitted from a backlighting unit to an image display panel, the backlighting unit including at least one light source and an optical plate optical plate having at least one accommodating part on a first surface thereof to accommodate a respective one of the at least one light source, the method comprising:
emitting light from the at least one light source through the respective at least one accommodating part;
transmitting a first portion of the emitted light to the image display panel;
refracting a second portion of the emitted light on a second surface of the optical plate and transmitting the refracted second portion of the emitted light to the image display panel at an angle less than a predetermined angle; and
reflecting a third portion of the emitted light between the first and second surfaces of the optical plate and transmitting the reflected third portion of the emitted light to the image display panel at an angle greater than a predetermined angle.

24. The method according to claim 23, wherein the second surface of the optical plate includes a recess at a location corresponding to the at least one accommodating part, the method further comprising:
refracting at least one of the first and second portions of the emitted light through the recess before transmitting the at least one of the first and second portions of the emitted light to the image display panel.

25. The method according to claim 23, wherein the second surface of the optical plate includes a bump at a location corresponding to the at least one accommodating part, the method further comprising:
reflecting the third portion of the emitted light on the bump before transmitting the third portion of the emitted light to the image display panel.
